(19) United States
(12) Patent Application Publication
(10) Pub. No.: US 2014/0184613 A1
(43) Pub. Date: Jul. 3, 2014

(54) METHOD FOR OFFLOADING GRAPHIC PROCESSING UNIT (GPU) PROCESSING TASKS TO REMOTE COMPUTERS

(71) Applicants: Doron Exterman, Ramat-Gan (IL); Eyal Maor, Hod Hasharon (IL)

(72) Inventors: Doron Exterman, Ramat-Gan (IL); Eyal Maor, Hod Hasharon (IL)

(21) Appl. No.: 13/732,373

(22) Filed: Jan. 1, 2013

(51) Int. Cl. G06T 1/20

(52) U.S. Cl. CPC G06T 1/20
USPC 345/501

(57) ABSTRACT

A method for remote execution of a process, the method may include receiving by a helper computer a process request that is sent from an initiator agent hosted by an initiator computer; wherein the process request comprises (a) a request to perform a process that utilizes a graphical processing unit (GPU) of the helper computer and (b) a process environment; and executing the process by the helper computer; wherein the executing comprises at least one out of: (a) utilizing a dynamic link library (DLL) of the helper computer; and
(b) fetching a file from the initiator computer.

### BACKGROUND

The amount and complexity of processes that require Graphic processing units (GPUs) has dramatically increased during the last decade. There is a growing need to expedite the execution of such processes.

### SUMMARY OF THE INVENTION

There may be provided a method for remote execution of a process, the method may include: receiving by a helper computer a process request that is sent from an initiator agent hosted by an initiator computer; wherein the process request comprises (a) a request to perform a process that utilizes a graphical processing unit (GPU) of the helper computer and (b) a process environment; and executing the process by the helper computer; wherein the executing comprises at least one out of: (a) utilizing a dynamic link library (DLL) of the helper computer; and (b) fetching a file from the initiator computer.

Further embodiments of the invention include a computer readable medium that is non-transitory and may store instructions for performing the mentioned above and/or below methods and any steps thereof, including any combinations of same.

Additional embodiments of the invention include a system arranged to execute any or all of the methods described below and/or above, including any stages—and any combinations of same. The system can be an initiator computer a helper computer or a combination thereof.

The method may include utilizing the DLL of the helper computer.

The DLL may be a DLL of the GPU of the helper computer.

The executing may include modifying the process request to include a request to retrieve the DLL of the GPU of the helper computer instead of a request to retrieve a DLL of a GPU of the initiator computer.

The executing may include modifying the process request to include a request to retrieve the DLL of the helper computer instead of a request to retrieve a DLL of the initiator computer.

The process environment may include a DLL of the helper computer.

The method may include fetching the file from the initiator computer.

The process request may include location information indicative of a location of the file in the initiator computer.

The fetching of the file may be followed by storing the file at a new location at the helper computer and wherein the executing may include modifying the process to fetch the new file from the new location.

The method may include sending to an operating system of the helper computer the new location instead of the location of the file in the initiator computer.

The executing may include intercepting commands related to the execution of the process before the commands reach the operating system of the helper computer.

The method may include updating a coordinator with a status of the helper computer.

There may be provided a method for remote execution of a process, the method may include: intercepting a request to execute a process, the request being aimed to an operating system of a initiator computer, wherein an execution of the process involves utilizing a graphical processing unit (GPU); determining to remotely execute the process by a helper computer; sending a process request to the helper computer, wherein the process request may include (a) the request to execute the process and (b) a process environment; receiving a request to provide a file associated with the execution of the process to the helper computer; providing the file to the helper computer; and receiving an outcome of the execution of the process from the helper computer.

The method may include preventing a provision of a dynamic link library (DLL) to the helper computer.

The method may include removing the DLL from the process environment.

The DLL may be a DLL of a GPU

The DLL may be a DLL of the operating system of the initiator computer.

The method may include executing the process by the initiator computer is it is determined not to remotely execute the process by the helper computer.

The determining is responsive to an amount of resources required to execute the process.

The method may include requesting from a coordinator at least one available helper computer for execution of the process; receiving from the coordinator the at least one available helper computer and selecting one of the available helper computer as the helper computer.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an initiator computer and a helper computer according to an embodiment of the invention;

FIG. 2 illustrates an initiator computer and a helper computer according to an embodiment of the invention;

FIG. 3 illustrates an initiator computer and a helper computer according to an embodiment of the invention;

FIG. 4 illustrates a method according to an embodiment of the invention;

FIG. 5 illustrates a method according to an embodiment of the invention; and

FIG. 6 illustrates a coordinator, an initiator computer and a helper computer according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

In the following detailed description, numerous specific details may be set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

The following terms can be used in this specification.

Task—A process which use the GPU or a process that executes a sub process that use the GPU.

Job—the entire execution tree that is being executed.

Initiator computer—the computer which initiated the job.

Helper computer—the remote computer to which the job is being offloaded to.

Agent—a software component which is installed on all initiators and helpers computers and communicates between Initiator computer and Helper computer

There is provided a method, a non-transitory computer readable medium and a system that allow execution of tasks which use the GPU power on different computer(s) than the computer on which these tasks were originally meant to be executed.

By allowing the entire process flow to distribute tasks to remote computers a use the GPU power of the remote computers (helpers) instead or along with the GPU power of the initiator computer (Initiator) a very significant performance to the over whole execution of the entire flow can be gained. When a process is assigned to execute on a Helper, the remote process runs on the Helper computer in a special environment representing the Initiating machine's environment that the process requires for correct execution. This environment may be constructed for the remote process on demand (run-time) by the agent. Only the part of the environment that the process requires for correct execution is constructed and not the entire environment of the Initiating machine (we want to remove all occurrences of the word virtualization). Any child processes run by this process will also run on the special environment created by the agent.

The constructed environment fully emulates the initiator computer's environment for the remotely executed process: file system, registry, Process DLLs, standard output, and directory information. All remotely-performed Tasks run in this encapsulated environment. There is no need to copy files from the original computer or install applications on remote computers, the special environment is constructed for the remote processes on the fly while the processes request these resources.

The entire file system of the initiator computer that will be required by the remote process (and only the file system that will be required by the process) will be synchronized to the remote machine on demand by means that will be described later on. The networks of computers to which the Initiator computer can distribute tasks transform the Initiator computer to a “supercomputer” both in terms of memory CPU and GPU power.

This technology allows the described benefits with the following advantages compared to a cluster solution (for example):

a. No changes to existing source code and architecture

b. No resource management, prior setups or installations

c. No maintenance of virtualization system image repositories

d. No virtualization software is needed (such as VMWare for example)

e. No dedicated hardware required

f. Extremely rapid and cost-effective implementation

In order for a task to be executed on a remote computer (helper), instead of executing the task as-is, the entire command line which represents the task's execution will be passed to the Initiator Agent.

The Initiator agent communicates with the Helper agent and sends him the command line to be executed along with the task's environment block and the process file itself (the executable file)

The helper agent executes the task on the helper computer

The helper agent injects a code to the process. The injected code intercepts all the task's communication with the operating system

Once the task requests any File-System request, for example a file c:\a.txt which exists on the initiating (local) computer and not the remote computer

The file is synched on the fly from the initiator computer to the remote computer and is cached there under a special directory

The call to the operating system is changed in a way that will reflect the path to the cached file instead of the original path. The OS call for example will be changed to open file “C:\Software Cache\a.txt” instead of the original path “C:\a.txt”.

Same synchronization, caching and change of the command line will be applied to registry calls, DLL loading, Executable calls, process output and input, etc.

The above will allow the task to run on the remote computer but all his environment will reflect the initiator computer, except for:
a. Task's calls to operating system specific DLLs and assemblies will not be synchronized from the initiator computer, but will work with the original computer's files. This will allow inter-operability between operating systems of the same family. For example in the Windows operating system family a Windows 7 initiator will be able to use XP helper computers.
b. Files which are part of the GPU driver installation will also not be synched from the initiator computer (in order for the Helper to be able to work with the GPU hardware it should use the dedicated driver DLLs for the specific GPU). This will allow the following:
   i. Initiator A with GPU G-A will be able to distribute tasks to Helper B with GPU G-B. These tasks, when using the GPU G-B will use the driver which will be able to work with this GPU
   ii. Initiator A without a GPU will be able to distribute tasks to Helper B with a GPU.
   iii. Initiator A with an on-board GPU will be able to distribute tasks to Helper B with a discrete GPU

Initiator A with either on-board or discrete GPU will be able to distribute tasks to helpers without GPUs (in such case the task will only use the CPU of this helper, if the task was written in a way that allows it to do so).

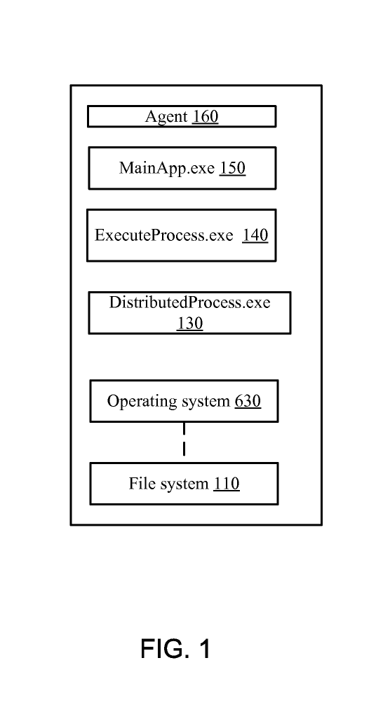

FIG. 1 illustrates an initiator computer 100 according to an embodiment of the invention.

In the initiator computer 100 there is a software component which is installed and is responsible for the connection and synchronization with the remote computers (Helpers)—in this diagram it is named “Agent” 160.

MainApp.exe 150 executes a process (DistributedProcess.exe) using a dedicated execution process that instead of executing the process on the local computer will execute it on the remote computer (the user can configure his agent to also execute “distributed processes” on the local machine if it has unused processing power and only if the processing power of the local machine is used to execute it on remote machines)

MainApp.exe 150 will pass to the ExecuterProcess.exe 140 the command line for executing DistributedProcess.exe 130. Distributed process.exe can communicate with operating system 120 and file system 110 of the initiating computer.

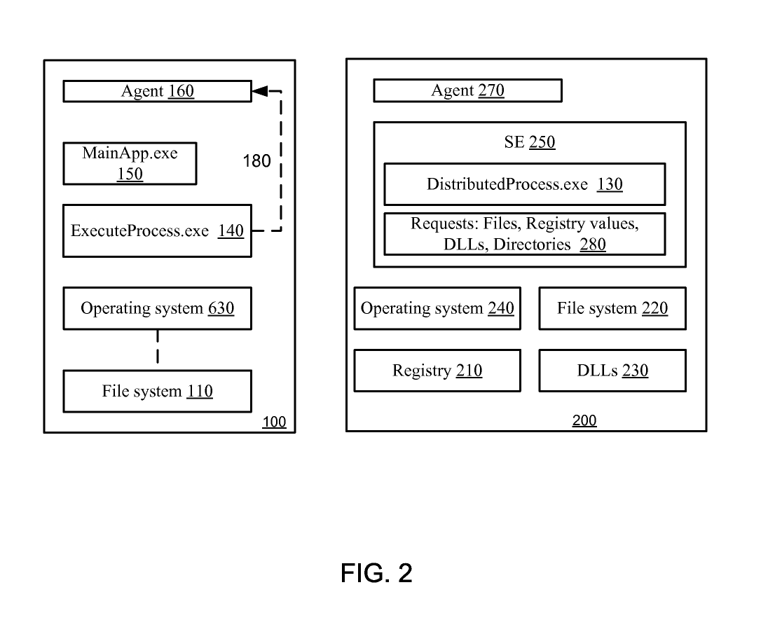

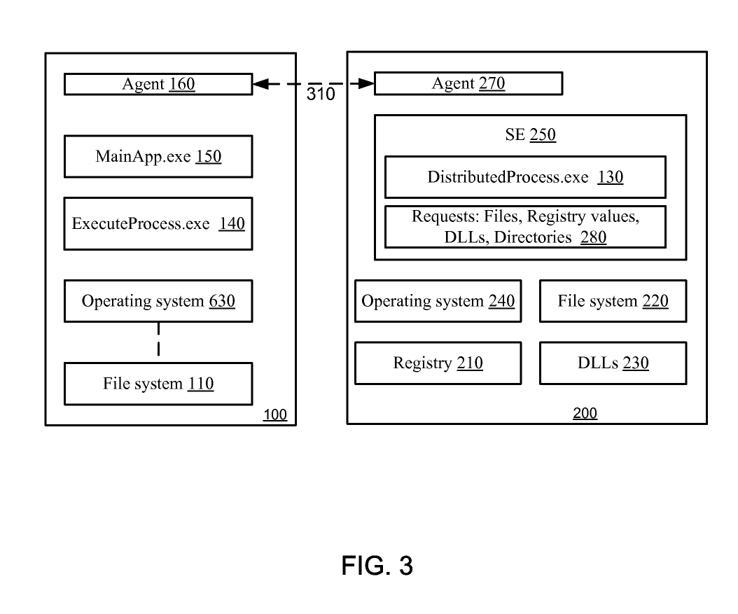

FIGS. 2 and 3 illustrate an initiator computer 100 and a helper computer 200 wherein the ExecuterProcess.exe executes DistributedProcess.exe remotely, according to an embodiment of the invention.

Executerprocess.exe 140 requests (180) the local agent 160 to execute the task on a remote computer.

The local Agent 160 connects to another Agent 270 on a remote computer 200 (for example—using tcp/ip) and requests it to execute the command line that was passed to ExecuterProcess.exe 140 (along with the process file—DistributedProcess.exe 140 itself and the system environment that the process should be executed in (system variables, paths, etc))

The remote Agent 270 copies the DistributedProcess.exe 130 file on a dedicated cache directory on the remote computer 200 and executes the command that the local Agent requested. It will also create the process with the environment received from the local machine and not the environment of the remote machine.

The remote Agent 270 will inject to DistributedProcess.exe 130 code that will intercept all the calls which DistributedProcess.exe 130 will perform against the operating system 240.

FIG. 2 illustrates the remote computer (helper computer) 200 as including operating system 240, registry 210, file system 220 and DLLs 230. Helper computer 200 also includes a GPU and cache memory. Remote computer hosts a special environment 250 in which DistributedProcess.exe 130 is being executed.

FIG. 3 illustrates that the execution may involve exchanging data, DLLs and the like between the initiator and remote computers 100 and 200.

DistributedProcess.exe 130 will execute windows API methods against the OS 240. These methods will be intercepted by the special environment (SE) 250.

The injected code 250 will have intimate knowledge of all the Windows API methods and will know which methods are related to data which should be brought from the Initiator computer 100 and which API methods can be forwarded to the remote OS without intervention. (There are sometimes methods which are not “file system” data related. for example, an API method might request the computer name. It is noted that the injected code should be familiar with this API method in order to return a result containing the Initiator machine's name and not the remote. This can be done directly by the injected code (returning the result)

Once intercepting a method which require data that resides in the initiator computer 100 (for example an input file, application DLL or directory information), the injected code 250 will halt the Windows API method and will request the data from the remote Agent 270.

The remote Agent will request the data from the local Agent 160.

Once the local Agent 160 will synch the data to the remote Agent 270, the remote Agent 270 will cache the data in a special location.

If the data requested is a file, the special environment 250 will change the Windows API method to reflect the file's location in the cached path.

If the data is a registry value directory information or special information related to the initiating machine (for example, machine name), the special environment 250 will fill the result of the Windows API method itself with the relevant information instead of allowing the method to reach the remote computer's OS 240.

The special environment 250 will only intervene with file system related calls allowing all other OS calls to be executed against the remote computer's OS un-interfered. For example, Windows methods that are related to GPU/CPU processing, memory allocation requests, etc.

The special environment 250 knows which DLLs are related to GPU driver installations. These DLLs will not be synchronized from the Initiator computer, resulting in every remote computer to work with its GPU and related drivers.

The special environment 250 knows which DLLs are related to the OS installation. These DLLs will not be synchronized from the Initiator computer, resulting in the ability for example for a Windows 7 OS to act as a Helper computer for an Initiating XP OS.

The special environment 250 will also send through the Agent components any process output/errors/etc

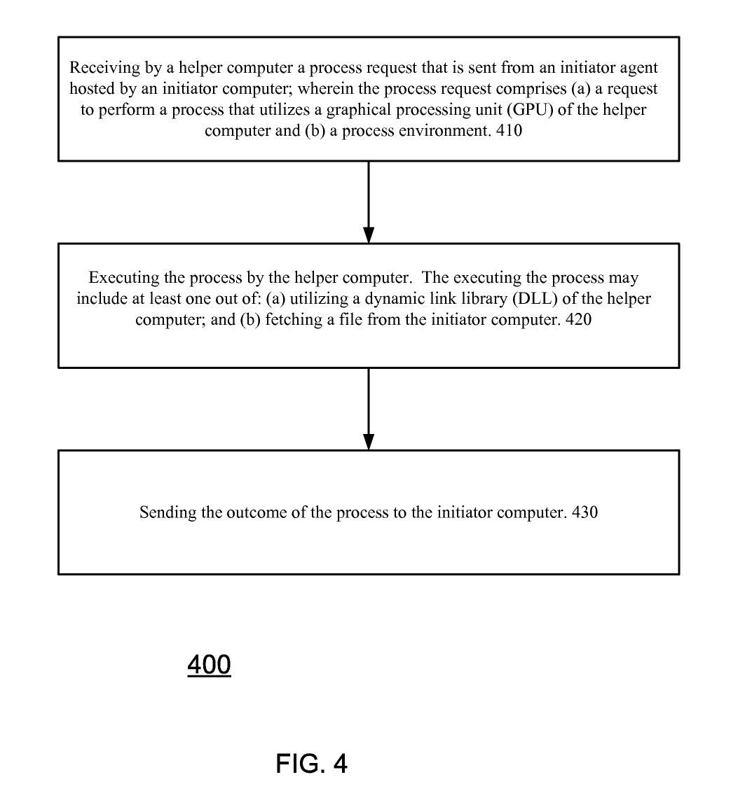

FIG. 4 illustrates method 400 according to an embodiment of the invention. Method 400 is for a remote execution of a process.

Method 400 may start by stage 410 of receiving by a helper computer a process request that is sent from an initiator agent hosted by an initiator computer; wherein the process request comprises (a) a request to perform a process that utilizes a graphical processing unit (GPU) of the helper computer and (b) a process environment.

Stage 410 may be followed by stage 420 of executing the process by the helper computer. Stage 420 of executing the process may include at least one out of: (a) utilizing a dynamic link library (DLL) of the helper computer; and (b) fetching a file from the initiator computer.

Stage 420 may include at least one of the following:
a. Utilizing the DLL of the helper computer. The DLL may be a DLL of the GPU of the helper computer or a DLL of an operating system of the helper computer.
b. Modifying the process request to include a request to retrieve the DLL of the GPU of the helper computer instead of a request to retrieve a DLL of a GPU of the initiator computer. For example a floating point DLL of the helper computer should be used instead of the floating point DLL of the initiator computer and thus the floating point DLL of the initiator computer will not be fetched from the initiator computer.
c. The process environment may include a DLL of the helper computer and stage 420 may include fetching and utilizing the DLL of the helper computer.
d. The process environment may include a DLL of the initiator computer and stage 420 may include fetching and utilizing the DLL of the initiator computer.
e. Fetching the file from the initiator computer.
f. The process request may include location information indicative of a location of the file in the initiator computer.
g. The fetching of the file is followed by storing the file at a new location at the helper computer and wherein the executing comprises modifying the process to fetch the new file from the new location. It is noted that the file will be cached on the remote machine, so if the next process that will be executed on that machine will request the same file, this file will be brought straight from the cache and won't need to be synchronized.
h. Sending to an operating system of the helper computer the new location instead of the location of the file in the initiator computer.
i. Intercepting commands related to the execution of the process before the commands reach the operating system of the helper computer.
j. Updating a coordinator with a status of the helper computer.

Stage 420 may be followed by stage 430 of sending the outcome of the process to the initiator computer.

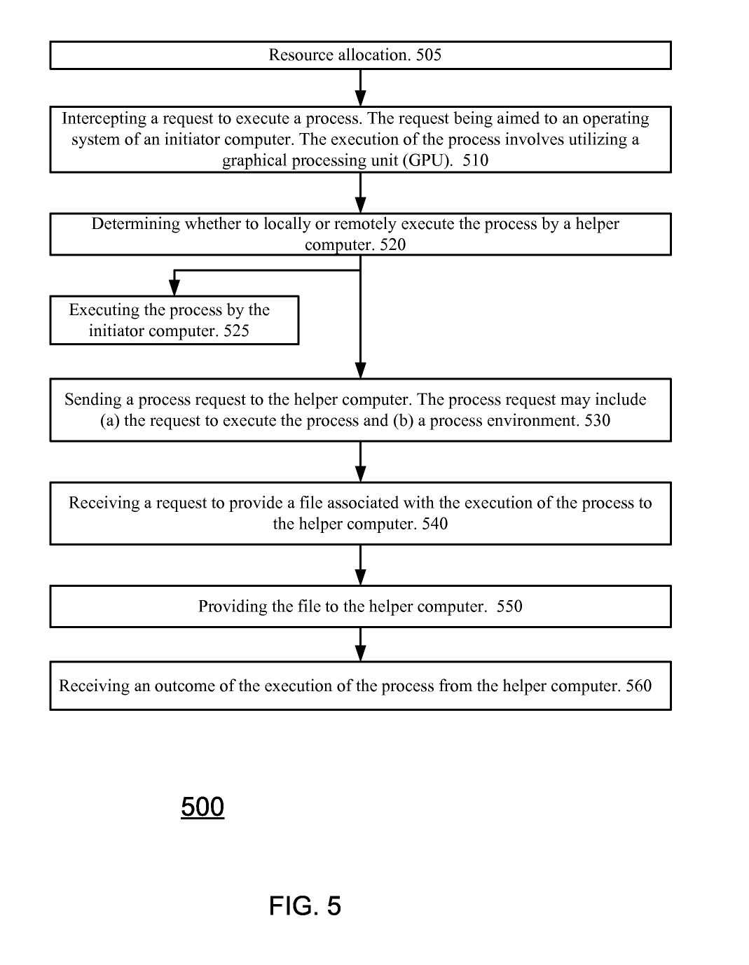

FIG. 5 illustrates method 500 according to an embodiment of the invention. Method 500 is for a remote execution of a process.

Method 500 may start by stage 510 of intercepting a request to execute a process. The request being aimed to an operating system of a initiator computer. The execution of the process involves utilizing a graphical processing unit (GPU).

Stage 510 may be followed by stage 520 of determining whether to locally or remotely execute the process by a helper computer.

The determining can be responsive to an amount of resources required to execute the process.

If it is determined not to remotely execute the process by the helper computer then stage 520 is followed by stage 525 of executing the process by the initiator computer.

If it is determined to remotely execute the process then stage 520 is followed by stage 530 of sending a process request to the helper computer. The process request may include (a) the request to execute the process and (b) a process environment.

Stage 530 may be followed by stage 540 of receiving a request to provide a file associated with the execution of the process to the helper computer.

Stage 540 may be followed by stage 550 of providing the file to the helper computer. Zero, one or multiple iterations of stages 540 and 550 can occur during the execution of the process.

Stage 550 (or stage 530) may be followed by stage 560 of receiving an outcome of the execution of the process from the helper computer.

Stage 530 may include preventing a provision of a dynamic link library (DLL) to the helper computer and even removing the DLL from the process environment.

The DLL can be a DLL of a GPU or of an operating system.

According to an embodiment of the invention the remote computer can be selected out of a list of available remote computers. Method 500 can include stage 505 of resource allocation. Stage 505 can include requesting from a coordinator at least one available helper computer for execution of the process; receiving from the coordinator the at least one available helper computer and selecting one of the available helper computer as the helper computer.

The resource allocation can be responsive to various requirements from the GPU (helper computer) to be allocated for executing the process—memory, available memory, GPU power, available GPU resources, GPU power consumption, speed of GPU, accuracy of GPU, latency associated with transfer of information between computers, and the like. The initiator computer can impose limitation on one or more of these parameters.

The initiator computer can trigger a remote execution of the process and if, before a completion of an execution of the process, a local GPU becomes available it may trigger a local execution of the process and may benefit from the results provided by one of the remote and local processes—for example from one that completes the execution of the process before the other.

It is noted that the resource allocation can be made on a GPU basis—thus the allocation is for GPUs and that a multi-le GPU helper computer can be regarded as having multiple resources.

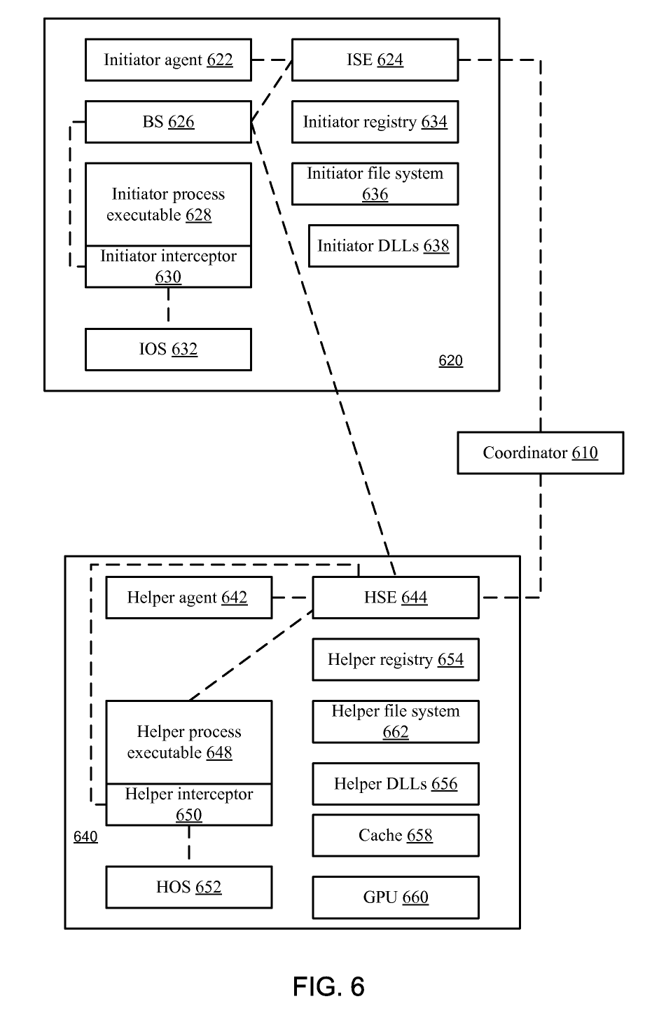

FIG. 6 illustrates a coordinator 610, an initiator computer 620 and a helper computer 640 according to an embodiment of the invention. It is noted that the terms initiator computer and helper computer refer to the function that these computer execute. Accordingly—a computer can be an initiator computer at certain periods of time, be a helper computer at other periods of time and can act as an initiator and a helper concurrently at further periods of time. It is noted that the coordinator can be installed on a different computer than the initiator computer or the helper computer but can be installed on the same computer as one of the initiator and helper computers.

The coordinator 610 can apply resource management policies on the initiator and helper computers that may for a grid of computers for executing processes. It can be configured to determine how GPUs should be allocated for remote and/or local tasks, amount of resources (minimal, typical, maximal) that can be used for remotely executing processes, the manner in which remote processes can be executed (constantly, as a background process, during predetermined periods only), set priorities between remote and local processing, set priorities between available GPUs and the like. The coordinator 610 can support redundancy schemes in case that one or more GPUS become unavailable or even when the coordinator itself is malfunctioning or otherwise unavailable. The coordinator 610 can obtain status information from initiator and helper computers in order to assist him in the resource allocation process.

The initiator computer 620 hosts:

a. an initiator agent 622,

b. an initiator service executable (ISE) 624,

c. a build system executable (BS) 626,

d. an initiator process executable 628,

e. an initiator interceptor 630,

f. an initiator operating system (10S) 632,

g. an initiator registry 634,

h. an initiator DLLs 638, and

i. an initiator file system 636 that may include one or more initiator files.

The helper computer 640 hosts:

a. a helper agent 642,

b. an helper service executable (HSE) 644,

c. a helper process executable 648,

d. a helper interceptor 650,

e. a helper operating system (HOS) 652,

f. a helper registry 654,

g. helper DLLs 656,

h. and a helper file system 652 that may include one or more helper files.

FIG. 6 also illustrates the helper computer 640 as including a helper cache memory (cache) 658 and a helper GPU 660.

The helper agent 642 and the initiator agent 622 can be installed on the helper computer 640 and the initiator computer 620 respectively. They can open various executables such as BE 464, ISE 624, BS 626 and the like. The agents can be configured to apply predefined policies such as polices related to status reports, remote or local execution policies, resource allocation polices, and the like. The BS 62 can install the ISE 624, the initiator process executable 628 and the initiator interceptor 630. The initiator interceptor 630 can be installed by injecting code into the initiator process executable 628 (The initiator interceptor is a file that is copied to the machine upon installation. The BuildSystem is responsible on injecting this piece of code to the process). The injection of code can be done by HSE 644 and it may be injected onto the helper process executable 648 and the helper interceptor 650. The helper interceptor 650 can be installed by injecting code into the helper process executable 648.

ISE 624 and HSE 644 can obtain status information about their respective computers (620, 640) and may send status information to coordinator 610. They (624, 644) can also send resource allocation requests to the coordinator 610 and receive its responses.

The following table provides a non-limiting example of an execution of a process.

It is assumed that the initiator process executable 648 starts executing a main tool (for example—a program (COMPRESS) that should compress 1000 files, each file should be compresses by a compress process (COMPRESS-PROCESS)—that should repeated 1000 times.

| | |
|---|---|
| 1 | The initiator process executable 648 executes COMPRESS - it outputs (towards |
| | IOS 632) a process request each to compress a file. The process request may include |
| | (a) the request to execute the process and (b) a process environment. The process |
| | request may include, for example, a reference to program COMPRESS, the process |
| | name (COMPRESS-PROCESS), the path to the process (the path within the |
| | initiator computer), and the process environment. The process environment can |
| | include DLLs or paths to DLLs and the like. |
| 2 | The initiator interceptor 630 intercepts the process request and sends it to BS 626 |
| 3 | BS 626 determines whether to execute COMPRESS-PROCESS locally or remotely |
| 4 | If BS 626 determines to execute COMPRESS-PROCESS locally it may manage its |
| | execution and eventually send IOS 632 the process request. |
| 5 | If BS 62 determines to execute COMPRESS-PROCESS remotely it may send IOS |
| | 632 a false handle message (indicating that the COMPRESS-PROCESS is being |
| | executed) and may start to assist in the remote execution of COMPRESS- |
| | PROCESS |
| 6 | If the coordinator 610 hasn't allocated a helper computer than BS 626 asks ISE 624 |
| | to send to coordinator 610 a request to get resources (GPUs of helper computers) for |
| | remotely executing the COMPRESS-PROCESS. The ISE 624 receives the list of |
| | available helper computers, sends it to the BS 626 that selects the helper computer. |
| 7 | BS 626 sends to the helper computer the process request. The process request can |
| | be received by the HSE 644. |
| 8 | HSE 644 executes the remote process and then injects injected code into this |
| | process - the Helper process executable 648. The helper executable 648 may |
| | change the process request to point to the COMPRESS-PROCESS stored in cache |
| | 658 (and not to its location in the initiator computer 620). |
| 9 | Helper process executable 648 starts executing the process COMPRESS- |
| | PROCESS. |
| 10 | During the execution of COMPRESS-PROCESS the helper interceptor 650 tries to |
| | find requests to fetch files associated with the execution of COMPRESS-PROCESS |
| | (such as the file to be compressed) and if it finds such a request it notifies BE 646 |
| | that may check whether the file (its most updated version) is already stored in the |
| | cache 658 and if so - BE 646 may sends to the HOS 652 information relating to the |
| | new location of the file so that the HOS 652 can fetch the file from the new location |
| | (in cache 658) - which may require modifying the request to fetch the file. If the |
| | file (most updated version) is not stored in the cache 658 then BE 464 requests the |
| | file from the initiator computer. |
| 11 | At the end of the execution of the process the helper computer may send the |
| | initiator computer the outcome of the process (for example a compressed file). |

According to an embodiment of the invention the BS 620 or a user can amend the program to be executed, for example to be executed in a parallel manner instead of a serial manner. For example, the program COMPRESS can be amended to initiate multiple COMPRESS-PROCESSES in parallel—without waiting to a completion of a compression of one file before initiating the compression of another file. A script can be written to include initiations of different COMPRESS-PROCESS processes.

Yet according to another embodiment of the invention the program can be amended to include limitation or conditions that will trigger remote or local execution of a process. For example—remote processing if the compresses file is bigger than a certain size.

According to an embodiment of the invention the remote task (remotely executing a process by the helper computer) can be executed on the helper computer while someone is working on that computer, using the idle GPU (and CPU) power

The GPUS can be arranged in Tesla units or any other stack of GPUs.

The GPUs can be stand alone GPUS or integrated with other cores such as central processing units (CPUs) or general purpose processors.

We can include a mechanism that will be able to describe to the minimum requirements (in terms of GPU hardware) for the Coordinator component (this component allocates Helper computers to an Initiator).

a. Every Helper computer will provide it's GPU details
b. The Initiator computer will request helpers with specific minimum GPU requirements (there are many different properties that describe a GPU, a minimum\maximum values can set for each such property)
c. The Coordinator element will only assign Helpers which qualify for the requirements set by the Initiator computer.
d. Managing the distribution of multiple tasks on multiple helpers on both GPU and CPU where the system decides which task should be best processed by an available GPU or CPU as the case maybe based on different parameters relating to the GPU or CPU characteristics as well as the Task characteristics.

Given an application which spawns 100 processes, each of them using the GPU and takes 1 minute to execute, the entire execution will take 100 minutes. Using the above technology will enable automatic distribution of these processes to 100 different computers in parallel finishing the entire execution in ˜1 minute.

This technology enables offloading a task from a computer with on-board GPU or with no GPU at all to a server computer with a discrete GPU (A discrete GPU can run 40 times faster and more from a regular on-board GPU)

Due to the fact that the same technology is currently applicable for CPUs, and OpenCL based process is able to use both or either the GPU and CPU. Executing an OpenCL process (task) on a remote computer will enable it to utilize whatever resources which are available there (as long as the software was written in a way that permits it). There are also processes that use OpenGL or DirectX which can utilize both GPU and CPU as well

The invention's technology will eliminate the necessity to:
a. Install a VM on the remote helper computers
b. Install the accelerated application or any of its sub-components on the helper computers (all the components that the process will require will be synched in run-time to the helper computers)
c. Transfer any input or output files (or text) the process which executes remotely might need.
d. One server machine can be used as Helper for various Initiating machine simultaneously (sharing its GPU power between them)
e. Machines which are currently used by their users can be utilized (their idle GPU and CPU cycles)

In a solution where GPU processes are being executed remotely (for example, a cluster solution), an image representing the initiator computers needs to be loaded on the remote computer and in order for another initiator to use the same computer, this VM needs to be un-loaded and a new VM (representing the new initiator computer) needs to be loaded. Using the technology mentioned above, any amount of different processes (tasks) from different computers can be executed simultaneously on the Helper computer; every process will be executed on its own environment while the GPU power will be shared by all of them.

This technology can allow applications to easily scale out to the public cloud

There are processes which have minimum GPU pre-requisites, part of the logic of assigning helper computers to an Initiator will be to check (using the agent software component which is installed on every Helper computer) the GPU available on each Helper computer and thus assigning as Helpers only computers which qualify to the minimum GPU requirements the process needs.

If a process can utilize any GPU, the technology will be able to distribute this process to any computer which has a GPU regardless of its type or vendor.

One of the main advantages of this technology is its ability to use existing hardware computers (ever while users are working on these computers) utilizing only the idle level of the GPU power. In most day-to-day use, only a fraction of the GPU power is utilized by a user working on a computer, leaving most of the GPU computing power idle and un-used.

This technology enables applications to use these idle GPU power resulting in:
a. Utilizing existing hardware to the full extent
b. Saving the need to purchase dedicated hardware to act as Helpers to which the processes will be distributed
c. Reducing energy cost
d. Reducing IT cost

The invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for remote execution of a process, the method comprises:
receiving by a helper computer a process request that is sent from an initiator agent hosted by an initiator computer; wherein the process request comprises (a) a request to perform a process that utilizes a graphical processing unit (GPU) of the helper computer and (b) a process environment; and
executing the process by the helper computer;
wherein the executing comprises at least one out of:
(a) utilizing a dynamic link library (DLL) of the helper computer; and
(b) fetching a file from the initiator computer.

2. The method according to claim 1, comprising utilizing the DLL of the helper computer.

3. The method according to claim 2, wherein the DLL is a DLL of the GPU of the helper computer.

4. The method according to claim 3, wherein the executing comprises modifying the process request to include a request to retrieve the DLL of the GPU of the helper computer instead of a request to retrieve a DLL of a GPU of the initiator computer.

5. The method according to claim 2, wherein the executing comprises modifying the process request to include a request to retrieve the DLL of the helper computer instead of a request to retrieve a DLL of the initiator computer.

6. The method according to claim 2, wherein the process environment comprises a DLL of the helper computer.

7. The method according to claim 1, comprising fetching the file from the initiator computer.

8. The method according to claim 7, wherein the process request comprises location information indicative of a location of the file in the initiator computer.

9. The method according to claim 8, wherein the fetching of the file is followed by storing the file at a new location at the helper computer and wherein the executing comprises modifying the process to fetch the new file from the new location.

10. The method according to claim 9, comprising sending to an operating system of the helper computer the new location instead of the location of the file in the initiator computer.

11. The method according to claim 1, wherein the executing comprises intercepting commands related to the execution of the process before the commands reach the operating system of the helper computer.

12. The method according to claim 1 comprising updating a coordinator with a status of the helper computer.

13. A method for remote execution of a process, the method comprises:
intercepting a request to execute a process, the request being aimed to an operating system of a initiator computer, wherein an execution of the process involves utilizing a graphical processing unit (GPU);
determining to remotely execute the process by a helper computer;
sending a process request to the helper computer, wherein the process request comprises (a) the request to execute the process and (b) a process environment;
receiving a request to provide a file associated with the execution of the process to the helper computer;
providing the file to the helper computer; and
receiving an outcome of the execution of the process from the helper computer.

14. The method according to claim 13, comprising preventing a provision of a dynamic link library (DLL) to the helper computer.

15. The method according to claim 14, comprising removing the DLL from the process environment.

16. The method according to claim 14, wherein the DLL is a DLL of a GPU.

17. The method according to claim 14, wherein the DLL is a DLL of the operating system of the initiator computer.

18. The method according to claim 13, comprising executing the process by the initiator computer is it is determined not to remotely execute the process by the helper computer.

19. The method according to claim 13, wherein the determining is responsive to an amount of resources required to execute the process.

20. The method according to claim 13 comprising requesting from a coordinator at least one available helper computer for execution of the process; receiving from the coordinator the at least one available helper computer and selecting one of the available helper computer as the helper computer.
